(19) United States
(12) Patent Application Publication
(10) Pub. No.: US 2004/0218169 A1
(43) Pub. Date: Nov. 4, 2004

(54) Preparing process of printing plate and printing plate material

(75) Inventor: Tatsuichi Maehashi, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KONICA MINOLTA MEDICAL & GRAPHIC, INC., Tokyo (JP)

(21) Appl. No.: 10/823,034

(22) Filed: Apr. 12, 2004

(30) Foreign Application Priority Data
Apr. 23, 2003 (JP) JP2003-117879

(51) Int. Cl. G03B 27/04

(52) U.S. Cl. 355/85; 355/47; 101/454

(57) ABSTRACT

Disclosed is a process of preparing a printing plate from a printing plate material comprising a support, and provided thereon, an image formation layer, the process comprising the steps of fixing the printing plate material onto a fixing member with suction through-holes by suction that evacuates air through the suction through-holes, the surface (rear surface) of the support opposite the image formation layer facing the fixing member, and then imagewise exposing the fixed printing plate material to laser to form an image on image formation portions of the image formation layer, wherein a degree of flatness of the surface on the image formation layer side of the fixed printing plate material is not more than 50 μm at the image formation portions.

### FIELD OF THE INVENTION

The present invention relates to a novel preparing process of a printing plate and a printing plate material, particularly to a preparing process of a printing plate providing excellent developability, excellent ink transferability, excellent printing image quality, and high printing durability, and to a printing plate material which is suitably used.

### BACKGROUND OF THE INVENTION

In recent years, a computer to plate system (CTP), in which an image data can be directly recorded in a printing plate material, has been widely used accompanied with the digitization of printing data. As a printing plate material usable for CTP, there are a printing plate material comprising an aluminum support such as a conventional PS plate, and a flexible printing plate material comprising a flexible resin film sheet and provided thereon, various functional layers.

Recently, in commercial printing industries, there is a tendency that many kinds of prints are printed in a small amount, and a printing plate material with high quality, which is inexpensive, has been required in the market. As a conventional flexible printing plate material, there are a silver salt diffusion transfer type printing plate material as disclosed in Japanese Patent O.P.I. Publication No. 5-66564, in which a silver salt diffusion transfer type light sensitive layer is provided on a flexible sheet, an ablation type printing plate material as disclosed in Japanese Patent O.P.I. Publication Nos. 8-507727, 6-186750, 6-199064, 7-314934, 10-58636 and 10-244773 in which a hydrophilic layer and a lipophilic layer, one of which is an outermost layer, are provided on a flexible sheet where the outermost layer is ablated by laser exposure to prepare a printing plate, and a heat melt type printing plate material as disclosed in Japanese Patent O.P.I. Publication No. 2001-96710 in which a hydrophilic layer and a heat melt image formation layer are provided on a flexible sheet where a hydrophilic layer or a heat melt image formation layer is imagewise heated by laser exposure to heat fix the image formation layer onto the hydrophilic layer.

The silver salt diffusion transfer type printing plate material requires a wet development step and a drying step after exposure, which does not give sufficient dimensional accuracy during the image formation step. The ablation type printing plate material does not require a wet development step, but image formation due to ablation is likely to fluctuate in dot shape. Further, there is problem in which the interior of the exposing apparatus or the printing plate surface is contaminated by scattered matters caused by ablation of the layer. The heat melt type printing plate material in which the heat melt image formation layer is fixed onto the hydrophilic layer, after image formation, is mounted on an off-set press. When on printing, a dampening water is supplied to the printing plate material, only the image formation layer at non-image portions is swollen or dissolved by the dampening water, and transferred to a printing paper (paper waste) to remove. Accordingly, a special development step is not required, and image formation due to heat melt provides a sharp dot shape, and prints with high image quality.

When laser exposure is carried out, a flexible printing plate material is generally fixed on a specific position of a flat or curved fixing member of an exposure device, and exposed. As methods of fixing a printing plate material on a fixing member, there are a vacuum fixing method in which a printing plate material is fixed on a fixing member with suction through-holes under reduced pressure, by evacuating air between the plate and the fixing member through the suction through-holes, a magnetically fixing method in which a printing plate material is fixed on a fixing member with a ferromagnetic surface by magnetic force, and a clamping method in which a printing plate material fixed on a fixing member by mechanically clamping the both edges thereof by clamps. The vacuum fixing method is preferably used, since operation is easy and its influence on a printing plate material is small.

However, a conventional flexible printing plate material has problems in uniformity of formed images (particularly, dot shape on a printing plate), printing durability, and reproducibility of registration accuracy on exposure. In order to solve the above problems, a planographic printing plate material has been proposed which comprises a support and provided thereon, a layer containing inorganic fine particles, light to heat conversion materials and materials capable of being melted by heat (see, for example, Japanese Patent O.P.I. Publication Nos. 2001-138652). This gives a printing plate material which is excellent in scratch resistance, an anti-staining property, an stain eliminating property, and printing durability. Only an improvement of a planographic printing plate material has a limitation, and improvement of an image formation device, which is used for preparing a printing plate, is also required.

Recently, environmental protection has been required in printing industries. A dampening water having a low content of isopropyl alcohol or a printing ink (for example, a soybean oil ink) removing a petroleum volatile solvent has been developed, and widely used. However, this dampening water or printing ink provides narrow latitude to a printing plate material used or printing conditions, as compared with a conventional one. Particularly, a flexible printing plate material employing laser for exposure has problems in image quality at shadow portions or ink transferability.

### SUMMARY OF THE INVENTION

An object of the invention is to provide a preparing process of a printing plate providing excellent developability, excellent ink transferability, excellent printing image quality, and high printing durability, and to provide a printing plate material providing a printing plate having excellent developability, excellent ink transferability, excellent printing quality, and high printing durability.

### BRIEF EXPLANATION OF THE DRAWINGS

FIG. 1 shows a schematic view of an exposure device employing the exposure drum in the invention.

FIG. 2 shows a schematic view of an exposure drum around which a printing plate material is wound.

FIG. 3 shows a schematic view of a flat fixing member (an exposure plate) wherein a printing plate material is fixed on the exposure plate by suction.

FIG. 4 shows a sectional view of an exposure drum around which a printing plate material is wound, the drum with suction through-holes having different aperture areas in the width direction (direction perpendicular to the circumference).

### DETAILED DESCRIPTION OF THE INVENTION

The above object has been attained by one of the following constitutions:

1. A process of preparing a printing plate from a printing plate material comprising a support, and provided thereon, an image formation layer, the process comprising the steps of fixing the printing plate material onto a fixing member with suction through-holes by suction that evacuates air through the suction through-holes, the surface (rear surface) of the support opposite the image formation layer facing the fixing member; and imagewise exposing the fixed printing plate material to laser to form an image on image formation portions of the image formation layer, wherein a degree of flatness of the surface on the image formation layer side of the fixed printing plate material is not more than 50 μm.

2. The process of item 1 above, wherein the fixing member is a cylindrical drum, and the imagewise exposure is carried out from the outside of the drum while the drum is rotated.

3. The process of item 1 above, wherein the aperture area of the suction through-holes at the central portion of the fixing member is smaller than that at the edge portions of the fixing member.

4. The process of item 1 above, wherein the printing plate material has a total thickness of from 150 to 300 μm, a stiffness of from 0.50 to 5.00 N, and an average density of from 1.4 to 1.8 g/m³.

5. The process of item 1 above, wherein the rear surface of the fixed printing plate material has a smoother value of not more than 0.06 MPa, and a coefficient of static friction of the rear surface to the fixing member is from 0.3 to 0.6.

6. The process of item 1 above, wherein the support is flexible.

7. The process of item 6 above, wherein the support is a polyethylene terephthalate or polyethylene naphthalate film sheet.

8. A printing plate material comprising a support, and provided thereon, an image formation layer, wherein the printing plate material is fixed onto a fixing member with suction through-holes according to a vacuum evacuation method, the surface (rear surface) of the support opposite the image formation layer facing the fixing member, and then the image formation layer is imagewise exposed to laser to form an image, a degree of flatness of the surface on the image formation layer side of the fixed printing plate material being not more than 50 μm.

9. The printing plate material of item 8 above, wherein the printing plate material has a total thickness of from 150 to 300 μm, a stiffness of from 0.50 to 5.00 N, and an average density of from 1.4 to 1.8 g/m³.

10. The printing plate material of item 8 above, wherein the rear surface of the fixed printing plate material has a smoother value of not more than 0.06 MPa, and a coefficient of static friction of the rear surface to the fixing member is from 0.3 to 0.6.

11. The process of item 8 above, wherein the support is flexible.

12. The process of item 11 above, wherein the support is a polyethylene terephthalate or polyethylene naphthalate film sheet.

13. The printing plate material of item 8 above, wherein the image formation layer contains a light-to-heat conversion material.

14. The printing plate material of item 8 above, further comprising a hydrophilic layer.

15 The printing plate material of item 14 above, wherein the image formation layer or the hydrophilic layer contains a light-to-heat conversion material.

1-1. A process of preparing a printing plate from a printing plate material comprising a support, and provided thereon, an image formation layer, the process comprising the steps of fixing the printing plate material onto a fixing member with suction through-holes according to a vacuum evacuation method, and imagewise exposing the image formation layer to laser to form an image, wherein a degree of flatness of the fixed printing plate material is not more than 50 μm at the image portions.

1-2. The process of item 1-1 above, wherein the fixing member is a cylindrical drum, and the imagewise exposure is carried out from the outside of the drum while the drum is rotated.

1-3. The process of item 1-1 or 1-2 above, wherein the aperture area of the suction through-holes at the central portion of the fixing member is smaller than that at the edge portions of the fixing member.

1-4. A printing plate material comprising a support, and provided thereon, an image formation layer, wherein the printing plate material is fixed onto a fixing member with suction through-holes according to a vacuum evacuation method, and then the image formation layer is imagewise exposed to laser to form an image, where a degree of flatness of the fixed printing plate material is not more than 50 μm at the image portions.

1-5. The printing plate material of item 1-4 above, wherein the printing plate material has a total thickness of from 150 to 300 μn, a stiffness of from 0.50 to 5.00 N, and an average density of from 0.3 to 0.6.

1-6. The printing plate material of item 1-4 or 1-5 above, wherein the rear surface of the support opposite the image formation layer has a smoother value of not more than 0.06 MPa, and a coefficient of static friction of the rear surface to the fixing member is from 0.3 to 0.6.

1-7. The printing plate material of any one of items 1-4 through 1-6 above, further comprising a hydrophilic layer, wherein the substrate is flexible, and the image formation layer or the hydrophilic layer contains a light-to-heat conversion material.

In view of the above, the present inventor has made an extensive study on a printing plate material and on a preparing process of a printing plate from the printing plate material, and have found a printing plate material and a preparing process of a printing plate providing high resolving power, excellent image uniformity, excellent image reproduction and a printing plate material used in this process. The preparing process of a printing plate from a printing plate material comprising a support, and provided thereon, an image formation layer, comprising the steps of fixing the printing plate material onto a fixing member with suction through-holes according to a vacuum evacuation method, the rear surface of the support opposite the image formation layer facing the fixing member, and imagewise exposing the image formation layer to laser to form an image, wherein a degree of flatness of the surface on the image formation layer side of the fixed printing plate material is not more than 50 μm at the image portions. The printing plate material used in the process comprises a support, and provided thereon, an image formation layer, wherein the printing plate material is fixed onto a fixing member with suction through-holes according to a vacuum evacuation method, the rear surface of the support opposite the image formation layer facing the fixing member, and then the image formation layer is imagewise exposed to laser to form an image, where a degree of flatness of the surface on the image formation layer side of the fixed printing plate material is not more than 50 μm at the image portions.

It is preferred that in the above process, the fixing member is a drum in the form of cylinder, and the imagewise exposure is carried out from the outside of the drum while the drum is rotated, or the aperture area of the suction through-holes at the central portion of the fixing member is smaller than that at the edge portions of the fixing member. It is preferred that in the above printing plate material, the material further has a total thickness of from 150 to 300 μm, a stiffness of from 0.50 to 5.00 N, and an average density of from 1.4 to 1.8 g/cm²; the material has a rear surface having a smoother value of not more than 0.06 MPa, and a coefficient of static friction of the rear surface to the fixing member is from 0.3 to 0.6 g/cm³; or the material further comprises a hydrophilic layer, wherein the support is flexible, and the image formation layer or the hydrophilic layer contains a light-to-heat conversion material.

Next, the present invention will be explained in detail.

Firstly, an image formation method used in the process of the invention preparing a printing plate will be explained employing figures.

The process of the invention preparing a printing plate is characterized in that the process comprises the steps of fixing a printing plate material onto a fixing member with suction through-holes according to a vacuum evacuation method, the printing plate material comprising a support, and provided thereon, an image formation layer, the rear surface of the support opposite the image formation layer facing the fixing member; and imagewise exposing the image formation layer to laser to form an image, wherein a degree of flatness of the surface of the image formation layer side of the fixed printing plate material is not more than 50 μm at the image portions.

Image formation on the printing plate material of the invention can be carried out by applying heat and preferably by infrared ray exposure.

In the invention, exposure for image formation is preferably scanning exposure, which is carried out employing a laser which can emit light having a wavelength of infrared and/or near-infrared regions, that is, a wavelength of from 700 to 1000 nm. As the laser, a gas laser can be used, but a semi-conductor laser, which emits light having a near-infrared region wavelength, is preferably used.

A device suitable for the scanning exposure in the invention may be any device capable of forming an image on the printing plate material according to image signals from a computer employing a semi-conductor laser.

Generally, the scanning exposures include the following processes.

(1) a process in which a plate material provided on a fixed horizontal plate is scanning exposed in two dimensions, employing one or several laser beams.

(2) a process in which the surface of a plate material provided along the inner peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

(3) a process in which the surface of a plate material provided along the outer peripheral wall of a fixed cylinder is subjected to scanning exposure in the rotational direction (in the main scanning direction) of the cylinder, employing one or several lasers located inside the cylinder, moving the lasers in the normal direction (in the sub-scanning direction) to the rotational direction of the cylinder.

In the invention, the process (3) above is preferable, and especially preferable when a printing plate material mounted on a plate cylinder of a printing press is scanning exposed.

One embodiment of the exposure device used for preparing a printing plate will be explained below, but the invention is not limited thereto.

The exposure device in the invention comprises a feed section in which a printing plate material is contained and plural transporting rollers for transporting the printing plate material, wherein an adhesive material is optionally provided on the surface of a part of the transporting rollers to form an adhesion roller. The adhesion roller can eliminate dust on the surface of the printing plate material and prevent image defects.

The exposure section comprises a fixing member having suction through-holes in the invention, for example, a plane fixing member (exposure plate) having suction through-holes or a cylindrical fixing member (exposure drum) having suction through-holes. The printing plate material transported was applied to the exposure plate or exposure drum by a pressure roller, cut into a specific length by a cutter, and brought into close contact with the exposure plate or exposure drum by suction, whereby the flatness of the surface to be exposed of the printing plate material is maintained. An exposure means (a laser writing means), which is capable of exposing the surface of the printing plate material on the exposure plate or exposure drum, is positioned facing the exposure plate or exposure drum.

Next, an exposure device will be explained below employing an illustration.

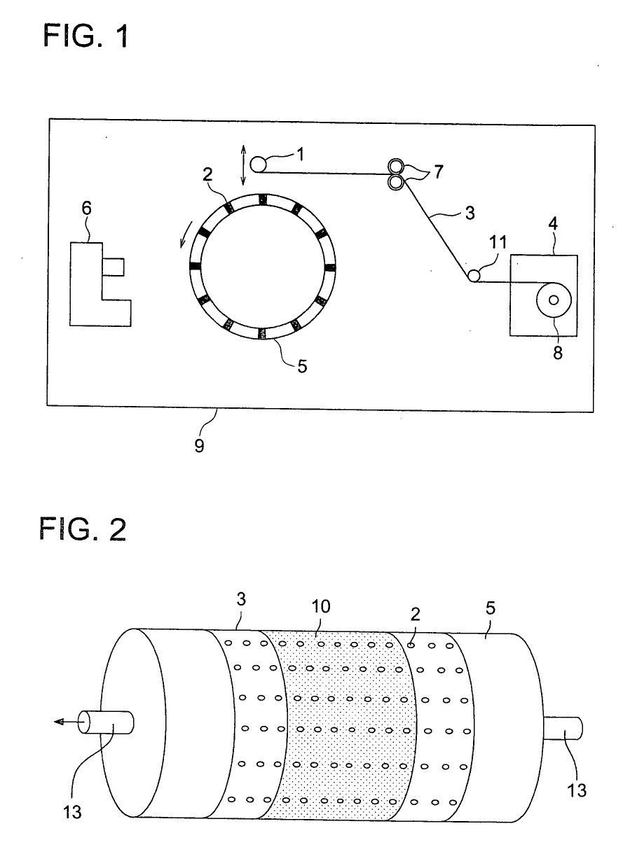

In FIG. 1, a printing plate material, which is to be transported to an exposure section composed of an exposure drum 5 with suction through-holes 2, and a laser writing means 6, is provided in a feed section 4 with the image formation layer facing outwardly. In FIG. 1, only one of a printing plate material roll 8 is provided in the feed section 4, but plural printing plate material rolls for preparing a different color plate can be optionally provided in the feed section.

The printing plate material 3 is fed from the feed section 4, passes through a transportation roller 11, and is transported to an adhesion roller 7 whose surface is covered with an adhesive material. The adhesion roller 7 is provided at a printing plate material feed section or at a printing plate material transportation section. In the exposure device in the invention, the surface (front or rear surface) of the printing plate material 3 contacts the adhesion roller 7, whereby foreign matter, dust or printing plate material pieces on the printing plate material surface are transferred to the adhesion roller to be removed to clean the printing plate material. The cleaned printing plate material provides a high fixing accuracy to the exposure drum 5 provided downstream, and removal of the foreign matter etc. from the image formation layer surface eliminates exposure defect (faults due to foreign matter) resulting from the foreign matter.

The printing plate material 3, which passes through the adhesion roller where foreign matter on the surface of the printing plate material is removed, is transported by the pressure roller 1 to the exposure drum 5, wound around the drum, and cut into a sheet with a certain length by a cutter (not illustrated). In the invention, the printing plate material 3 is fixed on the exposure drum 5 with the rear surface facing the exposure drum.

In FIG. 2, the printing plate material 3 is applied to the surface of the exposure drum 5, having in the surface many suction through-holes 2, by the pressure roller 1 (described in FIG. 1). Then, air in the drum being evacuated through the suction through-holes 2, the printing plate material 3, which has been cut into the sheet form above, is fixed (suction fixed) on the exposure drum whereby high flatness can be obtained.

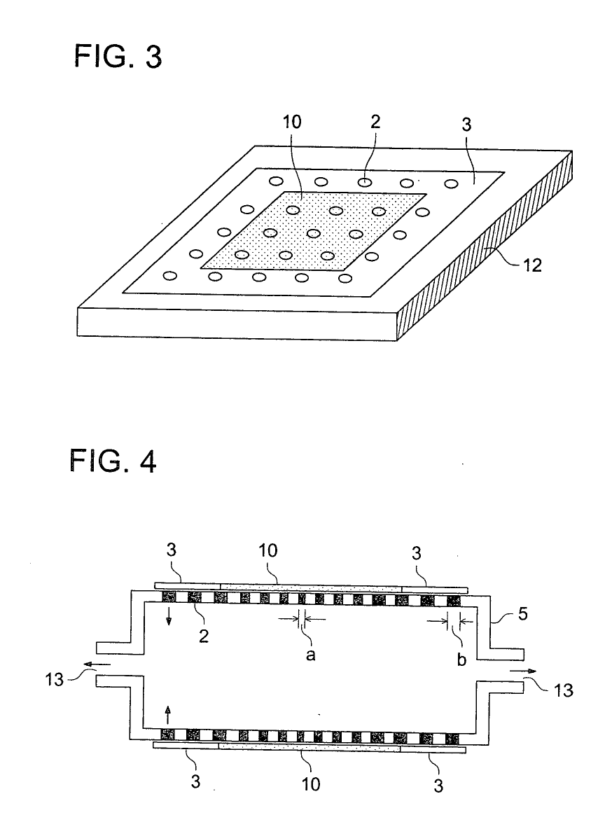

As is shown in FIG. 3, fixing of the printing plate material 3 to the surface of the plate fixing member 12 having suction through-holes 2 is carried out in the same way as above. Then, the printing plate material 3, which has been cut into the sheet form above, is suction fixed on the fixing member 12 through the suction through-holes 2. Subsequently, the image formation portions 10 of the printing plate material are imagewise exposed, employing a laser writing means provided so as to face the printing plate material 3.

The printing plate material 3 thus fixed on the exposure drum 5 or fixing member 12 is exposed to laser employing a laser writing means 6. Examples of laser include an argon laser, a He—Ne gas laser, a YAG laser, and a semiconductor laser.

In the invention, one of the characteristics is that a degree of flatness of the printing plate material, fixed on an exposure plate or an exposure by suction through the suction through-holes, is not more than 50 μm at the image formation portions 10 (portions to be exposed).

The degree of flatness falling within the range defined above at the image formation portions of the printing plate material can secure high uniformity of formed images (particularly shape of dots on the printing plate), stable printing durability, and accurate registration.

In the invention, when the printing plate material is fixed onto a fixing member with suction through-holes by suction so that the surface (rear surface) of the support opposite the image formation layer faces the fixing member, recesses are formed at the image formation layer at the suction through-hole portions of the fixing member. In the invention, a degree of flatness means a maximum distance between the image forming layer surface of the printing plate material fixed onto the fixing member and the bottom of recesses which are formed on the image formation layer at the suction through-hole portions of the fixing member under a reduced pressure of 300 mmHg. The degree of flatness is measured by means of a flatness meter Soaring Eye TS-8000 (produced by Soatec Corp.).

The aperture shape or aperture area of the suction through-holes provided in the fixing member is not specifically limited. The shape is ordinarily circular or rectangular, but the aperture shape, aperture area or density of the suction through-holes may vary due to the position at which the suction through-holes are provided. It is preferred that no portion of the periphery of the apertures of the suction through-holes protrudes.

In the invention, the aperture shape of the suction through-holes for fixing the image formation portions of the printing plate material onto the fixing member by suction is preferably circular. The aperture area of the suction through-holes is preferably from 0.5 to 5 mm². An aperture area falling within the above range can increase the suction fixing speed and fixing strength of the printing plate material onto the fixing member.

In order to further increase the suction fixing speed and fixing strength in the invention, the aperture area of the suction through-holes at the central portion of the fixing member, on which the central portion of printing plate material are to be fixed, are smaller than that of the suction through-holes at the edge portions of the fixing member on which the edge portions of printing plate material are to be fixed. Herein, “edge portions of printing plate material” refers to an area between the sides of printing plate material and a position 20 mm in from the sides of the printing plate material, and “the central portion of printing plate material” refers to the area inside the 20 mm wide perimeter of the printing plate material.

In FIG. 4, a printing plate material 3 is fixed on the exposure drum 5 having an exhaust port 13 and suction through-holes 2 by suction. In the invention, the aperture area “a” of the suction through-holes provided at the central portion of the drum is smaller than the aperture area “b” of the suction through-holes provided at the edge portions of the drum, (that is, a<b), whereby effective suction and high fixing strength can be realized. Herein, in FIG. 4, the central portion of the drum are portions where image formation portions 10 (portions to be exposed) of the printing plate material are to be provided.

In the invention, flatness of the printing plate material depends upon the following elements: 1) flatness of the fixing member, 2) unevenness of the printing plate material thickness, 3) degree of initial contact of the printing plate material with the fixing member or 4) strength of suction on suction fixing. Particularly, elements 3) and 4) have a great influence on the flatness, and are important in view of reproducibility.

It is preferred in the invention that the printing plate material has a total thickness of from 150 to 300 μm, a stiffness of from 0.50 to 5.00 N, and an average specific gravity of from 1.4 to 1.8 g/m³, which can provide high dissolving power, excellent image uniformity, and excellent image reproduction.

Stiffness can be measured, employing a stiffness tester available on the market, for example, “a stiffness tester UT-100-230” or “a stiffness tester UT-200GR” each produced by Toyo Seiki Seisakusho Co., Ltd.

Stiffness in the invention refers to a value obtained by being measured under the following conditions, employing a stiffness meter UT-100-230 produced by Toyo Seiki Seisakusho Co., Ltd.

<Measurement Conditions>

Sample size: 10 cm×8 cm (Effective area: 8 cm×8 cm)

Deflection angle: 10 degrees

Pushing amount: 2 mm

The stiffness in the invention of the printing plate material can be attained by a suitable combination of the following means:

(1) The substrate for the printing plate material is a plastic sheet having a modulus of elasticity at 120° C. (E120) of from 1000 to 6000 N/mm².

(2) The average thickness of the substrate for the printing plate material is from 100 to 300 μm.

(3) Orientation conditions are suitably controlled adjusted during manufacture of the substrate for the printing plate material.

(4) The moisture content of the substrate for the printing plate material is not more than 5% by weight.

(5) At least one hydrophilic layer is provided between the substrate and the image formation layer, the hydrophilic layer being porous.

(6) At least one hydrophilic layer is provided between the substrate and the image formation layer, the solid content of the dry hydrophilic layer being from 0.5 to 5 g/m².

(7) At least one conductive layer containing an electrically conductive material is provided on at least one side of the substrate.

It is preferred in the invention that in the printing plate material, the second (rear) surface has a smoother value of not more than 0.06 MPa, and a coefficient of static friction of the second (rear) surface to the fixing member is from 0.3 to 0.6, which can provide high resolving power, excellent image uniformity, excellent image reproduction.

The smoother value in the invention is a physical value described in the J. TAPPI paper pulp test No. 5. The value is obtained by measuring, as pressure, an air incorporation amount varying due to smoothness of the surface of the sample to be measured, employing a diffusion semiconductor pressure conversion device, and is a barometer of unevenness or a matted degree of the surface. The smoother value is defined as a pressure value (MPa) obtained by being measured according to the following conditions. Measurement is carried out employing a smoother SM-6B produced by Toei Denki Kogyo Co., Ltd. This device employing a vacuum type air micrometer measures a pressure of air introduced into the measuring head adsorbed onto a surface to be measured according to unevenness of the surface. A greater smoother value implies that the surface is rougher. When air in a measuring head, which is put on the surface to be measured, is evacuated through an aperture having a certain area by vacuum pump, air pressure P (MPa) in the head is measured as a smoother value. The printing plate material before the measurement is subjected to conditioning at 23° C. and at 60% RH (relative humidity) for 2 hours. In printing plate material of the invention, the smoother value is preferably not more than 0.06 MPa, and more preferably from 0.001 to 0.06 Mpa.

Coefficient of static friction in the invention is measured according to a static friction coefficient test in JIS K7125, and typically determined by the following.

The printing plate material was adhered to a horizontal base through an adhesive tape with the rear surface facing upward. A block (having a contact area of 20 mm² and a weight of 200 g), comprised of the same material as the base, was put on the rear surface, and the base was gradually inclined. An inclination angle θ of the base at which the block begins slipping was determined, and tan θ was defined as coefficient of static friction. As a measuring devise, for example, a static friction coefficient meter TRIOBOGEAR TYPE 10 produced by Shinto Kagaku Co., Ltd. is employed.

Next, the printing plate material of the invention will be explained below.

The support used in the printing plate material of the invention may be a substrate itself or a substrate having a specific layer such as a subbing layer or an anti-static layer. The substrate is not limited, but preferably a metal foil, a paper sheet, a plastic sheet or a composite thereof. Of these, the plastic sheet is more preferred in view of ease in handling.

In the printing plate material of the invention, the thickness of the substrate is preferably from 100 to 290 μm, and more preferably from 150 to 250 μm, in view of transportability in the exposure device and ease in handling as a printing plate material.

Examples of the plastic sheet include sheets of polyethylene terephthalate, polyethylene naphthalate, polyimide, polyamide, polycarbonate, polysulfone, polyphenylene oxide, and cellulose ester. The plastic sheet is preferably a polyethylene terephthalate sheet or a polyethylene naphthalate sheet.

It is preferred that an anti-static layer is provided on one side or on both sides of the substrate. When the anti-static layer is provided between the hydrophilic layer and the substrate, adhesion of the substrate to the hydrophilic layer is increased. The antistatic layer contains a polymer layer in which metal oxide particles or matting agents are dispersed. Examples of the metal oxides constituting the metal oxide particles include SiO₂, ZnO, TiO₂, SnO₂, Al₂O₃, In₂O₃, MgO, BaO, MoO₃, V₂O₅ and a composite thereof, and these metal oxides further containing hetero atoms. These may be used singly or in combination. The preferred metal oxides are SiO₂, ZnO, SnO₂, Al₂O₃, TiO₂, In₂O₃, and MgO.

The thickness of the antistatic layer is preferably from 0.01 to 1 μm.

In order to increase adhesion between the substrate and a hydrophilic layer, the surface of the plastic sheet may be subjected to corona discharge treatment, flame treatment, plasma treatment and UV light irradiation treatment. The surface can be mechanically roughened according to a sand blast method or a brush roughening method. The plastic sheet is preferably coated with a subbing layer containing latex having a hydrophilic group or a water soluble resin.

Next, a hydrophilic layer will be explained. Materials used in the hydrophilic layer of the printing plate material of the invention will be described below.

As material for forming a hydrophilic matrix layer is preferably used an organic hydrophilic matrix obtained by cross-linking or pseudo cross-linking an organic hydrophilic polymer, an inorganic hydrophilic matrix obtained by sol-to-gel conversion by hydrolysis or condensation of polyalkoxysilane, titanate, zirconate or aluminate, or metal oxides. The hydrophilic matrix layer preferably contains metal oxide particles. Examples of the metal oxide particles include particles of colloidal silica, alumina sol, titania sol and another metal oxide sol. The metal oxide particles may have any shape such as spherical, needle-like, and feather-like shape. The average particle size is preferably from 3 to 100 nm, and plural kinds of metal oxide each having a different size may be used in combination. The surface of the particles may be subjected to surface treatment.

The metal oxide particles can be used as a binder, utilizing its layer forming ability. The metal oxide particles are suitably used in a hydrophilic layer since they minimize lowering of the hydrophilicity of the layer as compared with an organic compound binder.

Among the above-mentioned, colloidal silica is particularly preferred. The colloidal silica has a high layer forming ability under a drying condition with a relative low temperature, and can provide a good layer strength. It is preferred that the colloidal silica used in the invention is necklace-shaped colloidal silica or colloidal silica particles having an average particle size of not more than 20 nm, each being described later. Further, it is preferred that the colloidal silica provides an alkaline colloidal silica solution as a colloid solution.

The hydrophilic matrix layer in the invention can contain porous metal oxide particles with a particle size of less than 1 μm as porosity providing agents. Examples of the porous metal oxide particles include porous silica particles, porous aluminosilicate particles or zeolite particles as described later.

The porous silica particles are ordinarily produced by a wet method or a dry method. By the wet method, the porous silica particles can be obtained by drying and pulverizing a gel prepared by neutralizing an aqueous silicate solution, or pulverizing the precipitate formed by neutralization. By the dry method, the porous silica particles are prepared by combustion of silicon tetrachloride together with hydrogen and oxygen to precipitate silica. The porosity and the particle size of such particles can be controlled by variation of the production conditions. The porous silica particles prepared from the gel by the wet method is particularly preferred.

The porosity of the particles is preferably not less than 1.0 ml/g, more preferably not less than 1.2 ml/g, and most preferably of from 1.8 to 2.5 ml/g, in terms of pore volume. The pore volume is closely related to water retention of the coated layer. As the pore volume increases, the water retention is increased, contamination is difficult to occur, and the water retention latitude is broad. Particles having a pore volume of more than 2.5 ml/g are brittle, resulting in lowering of durability of the layer containing them. Particles having a pore volume of less than 0.5 ml/g may be insufficient in printing performance.

Zeolite is a crystalline aluminosilicate, which is a porous material having voids of a regular three dimensional net work structure and having a pore size of 0.3 to 1 nm. Natural and synthetic zeolites are expressed by the following formula.

(M₁.(M₂)_{0.5})ₘ(AlₘSiₙO₂₍ₘ₊ₙ₎).xH₂O

In the above, M₁ and M₂ are each exchangeable cations. Examples of M₁ include Li⁺, Na⁺, K⁺, Tl⁺, Me₄N⁺ (TMA), Et₄N⁺ (TEA), Pr₄N⁺ (TPA), C₇H₁₅N²⁺, and C₈H₁₆N⁺, and examples of M² include Ca²⁺, Mg²⁺, Ba²⁺, Sr²⁺ and C₈H₁₈N₂. Relation of n and m is n≧m, and consequently, the ratio of m/n, or that of Al/Si is not more than 1. A higher Al/Si ratio shows a higher content of the exchangeable cation, and a higher polarity, resulting in higher hydrophilicity. The Al/Si ratio is within the range of preferably from 0.4 to 1.0, and more preferably 0.8 to 1.0. x is an integer.

Synthetic zeolite having a stable Al/Si ratio and a sharp particle size distribution is preferably used as the zeolite particles to be used in the invention. Examples of such zeolite include Zeolite A: Na₁₂(Al₁₂Si₁₂O₄₈).27H₂O; Al/Si=1.0, Zeolite X: Na₈₆(Al₈₆Si₁₀₆O₃₈₄).264H₂O; Al/Si=0.811, and Zeolite Y: Na₅₆(Al₅₆Si₁₃₆O₃₈₄).250H₂O; Al/Si=0.412.

Containing the porous zeolite particles having an Al/Si ratio within the range of from 0.4 to 1.0 in the hydrophilic layer greatly raises the hydrophilicity of the hydrophilic layer itself, whereby contamination in the course of printing is inhibited and the water retention latitude is also increased. Further, contamination caused by a finger mark is also greatly reduced. When Al/Si is less than 0.4, the hydrophilicity is insufficient and the above-mentioned improving effects are lowered.

The hydrophilic matrix layer constituting the hydrophilic layer of the printing plate material of the invention can contain layer structural clay mineral particles as a metal oxide. Examples of the layer structural clay mineral particles include a clay mineral such as kaolinite, halloysite, talk, smectite such as montmorillonite, beidellite, hectorite and saponite, vermiculite, mica and chlorite; hydrotalcite; and a layer structural polysilicate such as kanemite, makatite, ilerite, magadiite and kenyte. Among them, ones having a higher electric charge density of the unit layer are higher in the polarity and in the hydrophilicity. Preferable charge density is not less than 0.25, more preferably not less than 0.6. Examples of the layer structural mineral particles having such a charge density include smectite having a negative charge density of from 0.25 to 0.6 and bermiculite having a negative charge density of from 0.6 to 0.9. Synthesized fluorinated mica is preferable since one having a stable quality, such as the particle size, is available. Among the synthesized fluorinated mica, swellable one is preferable and one freely swellable is more preferable.

An intercalation compound of the foregoing layer structural mineral particles such as a pillared crystal, or one treated by an ion exchange treatment or a surface treatment such as a silane coupling treatment or a complication treatment with an organic binder is also usable.

With respect to the size of the planar structural mineral particles, the particles have an average particle size (an average of the largest particle length) of preferably not more than 20 μm, and more preferably not more than 10 μm, and an average aspect ratio (the largest particle length/the particle thickness of preferably not less than 20, and more preferably not less than 50, in a state contained in the layer including the case that the particles are subjected to a swelling process and a dispersing layer-separation process. When the particle size is within the foregoing range, continuity to the parallel direction, which is a trait of the layer structural particle, and softness, are given to the coated layer so that a strong dry layer in which a crack is difficult to be formed can be obtained. The coating solution containing the layer structural clay mineral particles in a large amount can minimize particle sedimentation due to a viscosity increasing effect. The particle size greater than the foregoing may produce a non-uniform coated layer, resulting in poor layer strength. The aspect ratio lower than the foregoing reduces the planar particles, resulting in insufficient viscosity increase and reduction of particle sedimentation inhibiting effect.

The content of the layer structural clay mineral particles is preferably from 0.1 to 30% by weight, and more preferably from 1 to 10% by weight based on the total weight of the layer. Particularly, the addition of the swellable synthesized fluorinated mica or smectite is effective if the adding amount is small. The layer structural clay mineral particles may be added in the form of powder to a coating liquid, but it is preferred that gel of the particles which is obtained by being swelled in water, is added to the coating liquid in order to obtain a good dispersity according to an easy coating liquid preparation method which requires no dispersion process comprising dispersion due to media.

An aqueous solution of a silicate is also usable as another additive to the hydrophilic matrix layer. An alkali metal silicate such as sodium silicate, potassium silicate or lithium silicate is preferable, and the SiO₂/M₂O is preferably selected so that the pH value of the coating liquid after addition of the silicate exceeds 13 in order to prevent dissolution of the porous metal oxide particles or the colloidal silica particles.

An inorganic polymer or an inorganic-organic hybrid polymer prepared by a sol-gel method employing a metal alkoxide. Known methods described in S. Sakka “Application of Sol-Gel Method” or in the publications cited in the above publication can be applied to prepare the inorganic polymer or the inorganic-organic hybridpolymer by the sol-gel method.

A water soluble resin may be contained in the hydrophilic layer in the invention. Examples of the water soluble resin include polysaccharides, polyethylene oxide, polypropylene oxide, polyvinyl alcohol, polyethylene glycol (PEG), polyvinyl ether, a styrene-butadiene copolymer, a conjugation diene polymer latex of methyl methacrylate-butadiene copolymer, an acryl polymer latex, a vinyl polymer latex, polyacrylamide, and polyvinyl pyrrolidone. In the invention, polysaccharides are preferably used as the water soluble resin.

As the polysaccharide, starches, celluloses, polyuronic acid and pullulan can be used. Among them, a cellulose derivative such as a methyl cellulose salt, a carboxymethyl cellulose salt or a hydroxyethyl cellulose salt is preferable, and a sodium or ammonium salt of carboxymethyl cellulose is more preferable. These polysaccharides can form a preferred surface shape of the hydrophilic layer.

The surface of the hydrophilic layer preferably has a convexoconcave structure having a pitch of from 0.1 to 50 μm such as the grained aluminum surface of an aluminum PS plate. The water retention ability and the image maintaining ability are raised by such a convexoconcave structure of the surface. Such a convexoconcave structure can also be formed by adding in an appropriate amount a filler having a suitable particle size to the coating liquid of the hydrophilic layer. However, the convexoconcave structure is preferably formed by coating a coating liquid for the hydrophilic layer containing the alkaline colloidal silica and the water-soluble polysaccharide so that the phase separation occurs at the time of drying the coated liquid, whereby a structure is obtained which provides a good printing performance.

The shape of the convexoconcave structure such as the pitch and the surface roughness thereof can be suitably controlled by the kinds and the adding amount of the alkaline colloidal silica particles, the kinds and the adding amount of the water-soluble polysaccharide, the kinds and the adding amount of another additive, a solid concentration of the coating liquid, a wet layer thickness or a drying condition.

Examples of the inorganic particles include well-known metal oxide particles include particles of silica, alumina, titania and zirconia. Porous metal oxide particles are preferably used in order to prevent sedimentation of the particles in a coating liquid. Examples of the porous metal oxide particles include the porous silica particles and the porous aluminosilicate particles described above.

The inorganic material coated particles include particles in which organic particles such as polymethyl methacrylate particles or polystyrene particles form cores and the cores are covered with inorganic particles having a size smaller than that of the cores. The particle size of the inorganic particles is preferably from 1/10 to 1/100 of that of the cores. Further, well-known metal oxide particles include particles of silica, alumina, titania and zirconia can be used as the inorganic particles. There are various covering methods, but a dry covering method is preferred in which the cores collide with the covering materials at high speed in air as in a hybridizer for the covering materials to penetrate the surface of the cores and fix them there.

Particles in which organic particles are plated with a metal can be used. Examples of such particles include Micropearl AU produced by Sekisui Kagaku Co., Ltd., in which resin particles are plated with a metal.

It is necessary that the particles have a particle size of not less than 1 μm, and satisfy inequality (1) described previously. The particle size is more preferably from 1 to 10 μm, still more preferably from 1.5 to 8 μm, and most preferably from 2 to 6 μm.

When the particle size exceeds 10 μm, it may lower dissolution of formed images or result in contamination of blanket during printing. In the invention, the content of the particles having a particle size of not less than 1 μm in the hydrophilic layer is suitably adjusted to satisfy the parameters regarding the invention, but is preferably from 1 to 50% by weight, and more preferably from 5 to 40% by weight, based on the hydrophilic layer. The content of materials containing a carbon atom such as the organic resins or carbon black in the hydrophilic layer is preferably lower in increasing hydrophilicity of the hydrophilic layer. The total content of these materials in the hydrophilic layer is preferably less than 9% by weight, and more preferably less than 5% by weight.

In the invention, an intermediate hydrophilic layer can be provided between the hydrophilic layer and substrate. As materials used for the intermediate hydrophilic layer, the same as those used in the hydrophilic layer described above can be used. However, that the intermediate hydrophilic layer is porous is not so advantageous. It is preferred that the intermediate hydrophilic layer is non-porous in view of layer strength. Therefore, the content of porosity providing agents in the intermediate hydrophilic layer is preferably lower than that in the hydrophilic layer, and it is more preferred that intermediate hydrophilic layer contains no porosity providing agents.

The content of the particles having a particle size of not less than 1 μm in the intermediate hydrophilic layer is preferably from 1 to 50% by weight, and more preferably from 5 to 40% by weight, based on weight of the intermediate hydrophilic layer.

It is preferred that the content of materials containing a carbon atom such as the organic resins or carbon black in the intermediate hydrophilic layer is lower in increasing hydrophilicity of the layer, as in the hydrophilic layer described above. The total content of these materials in the intermediate hydrophilic layer is preferably less than 9% by weight, and more preferably less than 5% by weight.

In the printing plate material of the invention, the hydrophilic layer above or a thermosensitive image formation layer described later preferably contains a light-to-heat conversion material.

Examples of the light-to-heat conversion material include infrared absorbing dyes, inorganic or organic pigment and metal oxides.

Examples of the light-to-heat conversion material include a general infrared absorbing dye such as a cyanine dye, a chloconium dye, a polymethine dye, an azulenium dye, a squalenium dye, a thiopyrylium dye, a naphthoquinone dye or an anthraquinone dye, and an organometallic complex such as a phthalocyanine compound, a naphthalocyanine compound, an azo compound, a thioamide compound, a dithiol compound or an indoaniline compound. Exemplarily, the light-to-heat conversion materials include compounds disclosed in Japanese Patent O.P.I. Publication Nos. 63-139191, 64-33547, 1-160683, 1-280750, 1-293342, 2-2074, 3-26593, 3-30991, 3-34891, 3-36093, 3-36094, 3-36095, 3-42281, 3-97589 and 3-103476. These compounds may be used singly or in combination.

Examples of pigment include carbon, graphite, a metal and a metal oxide. Furnace black and acetylene black is preferably used as the carbon. The graininess (d₅₀) thereof is preferably not more than 100 nm, and more preferably not more than 50 nm.

The graphite is one having a particle size of preferably not more than 0.5 μm, more preferably not more than 100 nm, and most preferably not more than 50 nm.

As the metal, any metal can be used as long as the metal is in a form of fine particles having preferably a particle size of not more than 0.5 μm, more preferably not more than 100 nm, and most preferably not more than 50 nm. The metal may have any shape such as spherical, flaky and needle-like. Colloidal metal particles such as those of silver or gold are particularly preferred.

As the metal oxide, materials having black color in the visible regions, or electro-conductive materials or semi-conductive materials can be used. Examples of the former include black iron oxide (Fe₃O₄), and black complex metal oxides containing at least two metals. Examples of the latter include Sb-doped SnO₂ (ATO), Sn-added In₂O₃ (ITO), TiO₂, TiO prepared by reducing TiO₂ (titanium oxide nitride, generally titanium black). Particles prepared by covering a core material such as BaSO₄, TiO₂, 9Al₂O₃.2B₂O and K₂O.nTiO₂ with these metal oxides is usable. The particle size of these particles is preferably not more than 0.5 μm, more preferably not more than 200 nm, and most preferably not more than 100 nm.

Of these light-to-heat conversion material, black iron oxide and black complex metal oxides containing at least two metals are preferred. Examples of the latter include complex metal oxides comprising at least two selected from Al, Ti, Cr, Mn, Fe, Co, Ni, Cu, Zn, Sb, and Ba. These can be prepared according to the methods disclosed in Japanese Patent O.P.I. Publication Nos. 9-27393, 9-25126, 9-237570, 9-241529 and 10-231441.

The complex metal oxide used in the invention is preferably a complex Cu—Cr—Mn type metal oxide or a Cu—Fe—Mn type metal oxide. The Cu—Cr—Mn type metal oxides are preferably subjected to the treatment disclosed in Japanese Patent O.P.I. Publication Nos. 8-27393 in order to reduce isolation of a 6-valent chromium ion. These complex metal oxides have a high color density and a high light-to-heat conversion efficiency as compared with another metal oxide.

The primary average particle size of these complex metal oxides is preferably not more than 1 μm, and more preferably from 0.01 to 0.5 μm. The primary average particle size of not more than 1 μm improves a light-to-heat conversion efficiency relative to the addition amount of the particles, and the primary average particle size of from 0.05 to 0.5 μm further improves a light-to-heat conversion efficiency relative to the addition amount of the particles. The light-to-heat conversion efficiency relative to the addition amount of the particles depends on a dispersity of the particles, and the well-dispersed particles have a high light-to-heat conversion efficiency. Accordingly, these complex metal oxide particles are preferably dispersed according to a known dispersing method, separately to a dispersion liquid (paste), before being added to a coating liquid for the particle containing layer. The metal oxides having a primary average particle size of less than 0.001 are not preferred since they are difficult to disperse. A dispersant is optionally used for dispersion. The addition amount of the dispersant is preferably from 0.01 to 5% by weight, and more preferably from 0.1 to 2% by weight, based on the weight of the complex metal oxide particles.

The addition amount of the light-to-heat conversion materials is preferably 0.1 to 50% by weight, more preferably 1 to 30% by weight, and most preferably 3 to 25% by weight based on the weight of the layer to which the material are added.

Next, a thermosensitive image formation layer (hereinafter also referred to as an image formation layer) will be explained.

The image formation layer in the invention preferably contains heat melt particles and/or heat fusible particles.

The heat melt particles used in the invention are particularly particles having a low melt viscosity, or particles formed from materials generally classified into wax. The materials preferably have a softening point of from 40° C. to 120° C. and a melting point of from 60° C. to 150° C., and more preferably a softening point of from 40° C. to 100° C. and a melting point of from 60° C. to 120° C. The melting point less than 60° C. has a problem in storage stability and the melting point exceeding 300° C. lowers ink receptive sensitivity.

Materials usable include paraffin, polyolefin, polyethylene wax, microcrystalline wax, and fatty acid wax. The molecular weight thereof is approximately from 800 to 10,000. A polar group such as a hydroxyl group, an ester group, a carboxyl group, an aldehyde group and a peroxide group may be introduced into the wax by oxidation to increase the emulsification ability. Moreover, stearoamide, linolenamide, laurylamide, myristylamide, hardened cattle fatty acid amide, parmitylamide, oleylamide, rice bran oil fatty acid amide, palm oil fatty acid amide, a methylol compound of the above-mentioned amide compounds, methylenebissteastearoamide and ethylenebissteastearoamide may be added to the wax to lower the softening point or to raise the working efficiency. A cumarone-indene resin, a rosin-modified phenol resin, a terpene-modified phenol resin, a xylene resin, a ketone resin, an acryl resin, an ionomer and a copolymer of these resins may also be usable.

Among them, polyethylene, microcrystalline wax, fatty acid ester and fatty acid are preferably contained. A high sensitive image formation can be performed since these materials each have a relative low melting point and a low melt viscosity. These materials each have a lubrication ability. Accordingly, even when a shearing force is applied to the surface layer of the printing plate precursor, the layer damage is minimized, and resistance to contaminations which may be caused by scratch is further enhanced.

The heat melt particles are preferably dispersible in water. The average particle size thereof is preferably from 0.01 to 10 μm, and more preferably from 0.1 to 3 μm. When a layer containing the heat melt particles is coated on a porous hydrophilic layer described later, the particles having an average particle size less than 0.01 μm may enter the pores of the hydrophilic layer or the valleys between the neighboring two peaks on the hydrophilic layer surface, resulting in insufficient on press development and background contaminations. The particles having an average particle size exceeding 10 μm may result in lowering of dissolving power.

The composition of the heat melt particles may be continuously varied from the interior to the surface of the particles. The particles may be covered with a different material. Known microcapsule production method or sol-gel method can be applied for covering the particles. The heat melt particle content of the layer is preferably 1 to 90% by weight, and more preferably 5 to 80% by weight based on the total layer weight.

The heat fusible particles in the invention include particles of a thermoplastic hydrophobic polymer. There is no specific limitation to the upper limit of the softening point of the thermoplastic hydrophobic polymer. It is preferred that the softening point of the thermoplastic hydrophobic polymer is lower than the decomposition temperature of the polymer. The weight average molecular weight (Mw) of the polymer is preferably within the range of from 10,000 to 1,000,000.

Examples of the thermoplastic hydrophobic polymer constituting the particles include a diene (co)polymer such as polypropylene, polybutadiene, polyisoprene or an ethylene-butadiene copolymer; a synthetic rubber such as a styrene-butadiene copolymer, a methyl methacrylate-butadiene copolymer or an acrylonitrile-butadiene copolymer; a (meth)acrylate (co)polymer or a (meth)acrylic acid (co)polymer such as polymethyl methacrylate, a methyl methacrylate-(2-ethylhexyl)acrylate copolymer, a methyl methacrylate-methacrylic acid copolymer, or a methyl acrylate-(N-methylolacrylamide); polyacrylonitrile; a vinyl ester (co)polymer such as a polyvinyl acetate, a vinyl acetate-vinyl propionate copolymer and a vinyl acetate-ethylene copolymer, or a vinyl acetate-2-hexylethyl acrylate copolymer; and polyvinyl chloride, polyvinylidene chloride, polystyrene and a copolymer thereof. Among them, the (meth)acrylate polymer, the (meth)acrylic acid (co)polymer, the vinyl ester (co)polymer, the polystyrene and the synthetic rubbers are preferably used.

The thermoplastic hydrophobic polymer may be prepared from a polymer synthesized by any known method such as an emulsion polymerization method, a suspension polymerization method, a solution polymerization method and a gas phase polymerization method. The particles of the polymer synthesized by the solution polymerization method or the gas phase polymerization method can be produced by a method in which an organic solution of the polymer is sprayed into an inactive gas and dried, and a method in which the polymer is dissolved in a water-immiscible solvent, then the resulting solution is dispersed in water or an aqueous medium and the solvent is removed by distillation. In both of the methods, a surfactant such as sodium lauryl sulfate, sodium dodecylbenzenesulfate or polyethylene glycol, or a water-soluble resin such as poly(vinyl alcohol) may be optionally used as a dispersing agent or stabilizing agent.

The heat fusible particles are preferably dispersible in water. The average particle size of the heat fusible particles is preferably from 0.01 to 10 μm, and more preferably from 0.1 to 3 μm. When a layer containing the heat fusible particles having an average particle size less than 0.01 μm is coated on the porous hydrophilic layer, the particles may enter the pores of the hydrophilic layer or the valleys between the neighboring two peaks on the hydrophilic layer surface, resulting in insufficient on press development and background contaminations. The heat fusible particles having an average particle size exceeding 10 μm may result in lowering of dissolving power.

Further, the composition of the heat fusible particles may be continuously varied from the interior to the surface of the particles. The particles may be covered with a different material. As a covering method, known methods such as a microcapsule method and a sol-gel method are usable. The heat fusible particle content of the layer is preferably from 1 to 90% by weight, and more preferably from 5 to 80% by weight based on the total weight of the layer.

In the invention, the image formation layer containing heat melt particles or heat fusible particles can further contain a water soluble material. When an image formation layer at unexposed portions is removed on a press with dampening water or ink, the water soluble material makes it possible to easily remove the layer.

Regarding the water soluble material, those described above as water soluble materials to be contained in the hydrophilic layer can be used. The image formation layer in the invention preferably contains saccharides, and more preferably contains oligosaccharides.

Among the oligosaccharides, trehalose with comparatively high purity is available on the market, and has an extremely low hygroscopicity, although it has high water solubility, providing excellent storage stability and excellent development property on a printing press.

When oligosaccharide hydrates are heat melted to remove the hydrate water and solidified, the oligosaccharide is in a form of anhydride for a short period after solidification. Trehalose is characterized in that a melting point of trehalose anhydride is not less than 100° C. higher that that of trehalose hydrate. This characteristics provides a high melting point and reduced heat fusibility at exposed portions of the trehalose-containing layer immediately after heat-fused by infrared ray exposure and re-solidified, preventing image defects at exposure such as banding from occurring. In order to attain the object of the invention, trehalose is preferable among oligosaccharides.

The oligosaccharide content of the component layer is preferably from 1 to 90% by weight, and more preferably from 10 to 80% by weight, based on the total weight of the layer.

A back coat layer can be provided on the rear surface of the printing plate material of the invention in order to obtain the smoothness and coefficient of static friction as defined in the invention. The back coat layer preferably contains a binder, a matting agent or a compound providing good surface lubricity or good conductivity.

Examples of the binder include gelatin, polyvinyl alcohol, methylcellulose, acetylcellulose, aromatic polyamides, silicone resins, alkyd resins, phenol resins, melamine resins, fluorine-contained resins, polyimides, urethane resins, acryl resins, urethane-modified silicone resins, polyethylene, polypropylene, Teflon (R), polyvinyl butyral, polyvinyl chloride, polyvinyl acetate, polycarbonates, organic boron compounds, aromatic esters, fluorinated polyurethane, polyether sulfone, polyesters, polyamides, polystyrene, and a copolymer containing as a main component a monomer unit contained in the resins or polymers described above.

Use of a cross-linked polymer as a binder is effective in preventing separation of the matting agent or improving scratch resistance in the back coat layer, and is effective for preventing blocking during storage. As the cross-linking method of the binder, heat, actinic light, pressure or their combination can be employed according to kinds of the cross-linking agent used, without special limitations. In order to improve adhesion of the support, an adhesive layer may be provided between the substrate and the back coat layer.

Examples of the matting agent include inorganic or organic particles. Examples of the organic particles include particles of silicone resins, fluorine-contained resins, acryl resins, methacryl resins, and melamine resins. Of these, particles of silicone resins, acryl resins, and methacryl resins are preferred. Other examples of the matting agent include particles of radical polymerization polymers such as polymethyl methacrylate (PMMA), polystyrene, polyethylene, polypropylene and others, and particles of polycondensation polymers such as polyesters and polycarbonates. Examples of the inorganic particles include particles silicon oxide, calcium carbonate, titanium dioxide, aluminum oxide, zinc oxide, barium sulfate, and zinc sulfate. Of these, titanium dioxide, calcium carbonate, and silicon oxide are preferred.

The average particle size of the particles is preferably from 0.5 to 10 μm, and more preferably from 0.8 to 5 μm. The average particles less than 0.5 μm cannot provide a sufficiently roughened back coat layer surface, requiring long evacuation time to uniformly fix the printing plate material to the fixing member. The average particles exceeding 10 μm provides an excessively roughened back coat layer surface and a high smoother value, so that the printing plate material cannot be stably fixed to the fixing member.

A back coat layer is provided in a coating amount of from 0.5 to 3 g/m² on a plastic sheet substrate. In the back coat layer in a coating amount of less than 0.5 g/m², coatability is unstable, causing problem of matting agent separation. In the back coat layer in a coating amount exceeding 3 g/m², the particle size of the matting agent increases, and produces embossing on the image formation layer side due to pressure from the back coat layer, resulting in lack or unevenness of images. The coating amount of a back coat layer containing no matting agent is preferably from 0.01 to 1.0 g/m².

The particle content of the back coat layer is preferably 0.5 to 80% by weight, and more preferably from 1 to 20% by weight, based on the total solid content of the back coat layer. The particle content of less than 0.5% by weight may not provide a sufficiently roughened back coat layer surface. The particle content exceeding 80% by weight provides an excessively roughened back coat layer surface and a smoother value falling outside the range defined in the invention, which may lower image quality.

The back coat layer preferably contains various surfactants, silicone oil, a fluorine-contained resin, or waxes, in order to improve lubricity of the surface.

An antistatic agent can be added to the back coat layer, in order to prevent transportation fault due to frictional electrification or adherence of foreign matter due to the electrification. Examples of the antistatic agent include a cationic surfactant, an anionic surfactant, a nonionic surfactant, a polymer antistatic agent, and electrically conductive particles. Of these, carbon black, graphite, particles of metal oxides such as tin oxide, zinc oxide or titanium oxide, or a conductive particles of semiconductors are preferably used. Carbon black, graphite, or particles of metal oxides are especially preferred, since a stable antistatic property can be obtained free from ambient conditions such as temperature.

Examples of the metal oxides constituting the metal oxide particles include SiO₂, ZnO, TiO₂, SnO₂, Al₂O₃, In₂O₃, MgO, BaO, MoO₃, V₂O₅ and a composite thereof, and metal oxides containing a hetero atom. These may be used singly or in combination. The preferred metal oxides of these are SiO₂, ZnO, SnO₂, Al₂O₃, TiO₂, In₂O₃, and MgO. Examples of the metal oxides containing a hetero atom include ZnO doped with a hetero atom such as Al or In, SnO₂ doped with a hetero atom such as Sb or Nb, and In₂O₃ doped with a hetero atom such as Sn, in which the doping content of the hetero atom is not more than 30 mol %, and more preferably not more than 10 mol %.

The metal particle content of the back coat layer is preferably from 10 to 90% by weight. The average particle size of the metal particles is preferably from 0.001 to 0.5 um. The average particle size of the metal particles herein refers to that of the metal particles including primary order particles and higher order particles.

The printing plate material of the invention preferably comprises a layer or a support each having a specific surface resistance of from 1×10⁸ to 1×10¹² Ω/m² at 80% RH. Various surfactants or electrically conductive materials are suitably added to a layer so that the layer has specific surface resistance of from 1×10⁸ to 1×10¹² Ω/m² at 80% RH. It is preferred that carbon black, graphite, or particles of metal oxides are added to a layer so that the layer has specific surface resistance of from 1×10⁸ to 1×10¹² Ω/m² at 80% RH.

When the printing plate material of the invention on the fixing member is exposed to laser, the printing plate material is preferably fixed on the fixing member so that displacement of the printing plate material is not caused, employing a combination of a vacuum suction method and another known method. In order to prevent blocking or to provide good fixation, the rear surface of the support is preferably roughened or is preferably provided with a back coat layer containing a matting agent. Such a rear surface has a surface roughness (Rz) of preferably from 0.04 to 5.00

### EXAMPLES

The present invention will be detailed employing the following examples, but the invention is not limited thereto. In the examples, “%” is % by weight, unless otherwise specified.

### Example 1

<<Preparation of Substrate (Plastic Film Sheet)>>

Employing terephthalic acid and ethylene glycol, polyethylene terephthalate having an intrinsic viscosity VI of 0.66 (at 25° C. in a phenol/tetrachloroethane (6/4 by weight) solvent) was prepared according to a conventional method. The resulting polyethylene terephthalate was formed into pellets, dried at 130° C. for 4 hours, and melted at 300° C. The melted polyethylene terephthalate was extruded from a T-shaped die onto a 50° C. drum, and rapidly cooled to obtain an unstretched film sheet. The resulting film sheet was biaxially heat-stretched to obtain substrates 1, 2, 3, 4 and 5, each composed of polyethylene terephthalate (abbreviated as PET in Table 4), which had a thickness of 150, 175, 200, 250 and 300 μm, respectively.

<<Coating of Subbing Layer on the Substrate>>

The surface on one side of the substrate obtained above was corona discharged under condition of 8 W/m²-minute, and coated with the following subbing layer coating solution (a) to give a first subbing layer with a dry thickness of 0.8 μm. Successively, the first subbing layer was corona discharged under condition of 8 W/m²·minute, and coated with the following subbing layer coating solution (b) to give a second subbing layer with a dry thickness of 0.1 μm. Thus, subbed substrates 1A, 2A, 3A, 4A, and 5A, each having subbing layers, were obtained.

| [Subbing layer coating solution (a)] | |
|---|---|
| Latex of styrene/glycidyl methacrylate/butyl acrylate | 6.3% |
| (60/39/1) copolymer (Tg = 75° C.) | (in terms of |
| | solid content) |
| Latex of styrene/glycidyl methacrylate/butyl acrylate | 1.6% |
| (20/40/40) copolymer | (in terms of |
| | solid content) |
| Anionic surfactant S-1 | 0.1% |
| Water | 92.0% |
| [Subbing layer coating solution (b)] | |
| Gelatin | 1.0% |
| Anionic surfactant S-1 | 0.05% |
| Hardener H-1 | 0.02% |
| Matting agent (Silica particles | 0.02% |
| with an average particle size of 3.5 μm) | |
| Antifungal agent F-1 | 0.01% |
| Water | 98.9% |

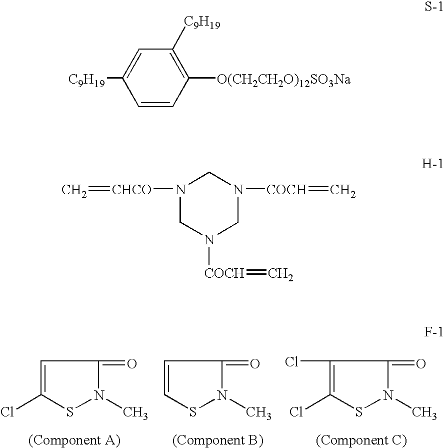

(Component A):(Component B):(Component C)=50:46:4 (by mole)<

<Preparation of Supports 1A through 5A>>

A back coat layer 1 (BC layer 1) was provided on the surface of each of the substrates 1A through 5A obtained above opposite the subbing layer according to the following procedures. Thus, supports 1A through 5A was prepared from substrate 1A through 5A, respectively.

The surface of the substrate obtained above opposite the subbing layer was corona discharged under condition of 8 W/m²·minute, and coated with the following subbing layer coating solution (c) to give a third subbing layer with a dry thickness of 0.8 μm. Successively, the third subbing layer was corona discharged under condition of 8 W/m²·minute, and coated with the following subbing layer coating solution (d) to give a second subbing layer with a dry thickness of 1.0 μm. Thus, supports 1A, 2A, 3A, 4A, and 5A, each having a subbing layer on both side of the substrate, were obtained.

| [Subbing layer coating solution (c)] | |
|---|---|
| Latex of styrene/glycidyl methacrylate/butyl acrylate | 0.4% |
| (20/40/40) copolymer | (in terms of |
| | solid content) |
| Latex of styrene/glycidyl methacrylate/butyl | 7.6% |
| acrylate/acetoacetoxyethyl methacrylate (39/40/20/1) | (in terms of |
| copolymer | solid content) |
| Anionic surfactant S-1 | 0.1% |
| Water | 91.9% |
| [Subbing layer coating solution (d)] | |
| Conductive composition of | |
| *Component d-11/Component d-12/Component d-13 | 6.4% |
| (=66/31/1) | |
| Hardener H-2 | 0.7% |
| Anionic surfactant S-1 | 0.07% |
| Matting agent (Silica particles | 0.03% |
| with an average particle size of 3.5 μm) | |
| Water | 93.4% |

*Component d-11 Copolymer of styrene sulfonic acid/maleic acid (50/50) (Anionic polymer)
*Component d-12 Latex of styrene/glycidyl methacrylate/butyl acrylate (20/40/40) copolymer
*Component d-13 Copolymer of styrene/sodium isoprene sulfonate (80/20) (Polymer surfactant)

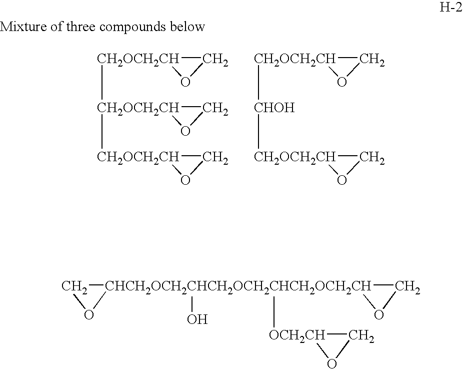

<<Preparation of Support 1B>>

The following coating solution was coated on the surface of the substrate 1A opposite the subbing layer to give a back coat layer 2 (BC layer 2) having a dry thickness of 2.5 g/m² and dried to prepare support 1B.

| | |
|---|---|
| Polyester resin (Vylon 200, produced | 9.0 parts |
| by Toyo Boseki Co., Ltd.) | |
| PMMA resin particles (MX-1000, | 0.3 parts |
| produced by Soken Kagaku Co., Ltd.) | |
| Carbon Black (a methyl ethyl ketone | 3.6 parts |
| dispersion of MH1 Black #271, | |
| produced by Shinetsu Kagaku Co., Ltd.) | |
| Silicon oil (X-24-8300, | 2.0 parts |
| produced by Shinetsu Kagaku Co., Ltd.) | |
| Propylene glycol monomethyl ether acetate | 40 parts |
| Toluene | 20 parts |
| Methyl ethyl ketone | 27.1 parts |

<<Preparation of Support 1C>>

The following coating solution was coated on the surface of the substrate 1A opposite the subbing layer to give a back coat layer 3 (BC layer 3) having a dry thickness of 0.6 g/m² and dried to prepare support 1C.

| | |
|---|---|
| Polyvinyl alcohol (EG-30, produced | 9.5 parts |
| by Nippon Gosei Kagaku Co., Ltd.) | |
| PMMA resin particles (MX-300, | 0.6 parts |
| produced by Soken Kagaku Co., Ltd.) | |
| Isopropyl alcohol | 20 parts |
| Water | 70 parts |

<<Preparation of Support 1D>>

The following coating solution was coated on the surface of the substrate 1A opposite the subbing layer to give a back coat layer 4 (BC layer 4) having a dry thickness of 0.3 g/m² and dried to prepare support 1D.

| | |
|---|---|
| Polyvinyl alcohol (EG-30, produced | 9.5 parts |
| by Nippon Gosei Kagaku Co., Ltd.) | |
| PMMA resin particles (MX-300, | 0.6 parts |
| produced by Soken Kagaku Co., Ltd.) | |
| Isopropyl alcohol | 20 parts |
| Water | 70 parts |

<<Preparation of Printing Plate Materials 1 through 8 (Inventive)>>

A hydrophilic layer 1 coating solution as shown in Table 1, a hydrophilic layer 2 coating solution as shown in Table 1, and an image formation layer coating solution as shown in Table 3 were coated on the subbing layer of each of the supports 1A through 1D, and supports 2A through 5A, employing a wire bar. Thus, printing plate materials 1 through 8 were prepared.

In the above, the hydrophilic layer 1 coating solution (Table 1) and the hydrophilic layer 2 coating solution (Table 1) were coated on the subbing layer in that order to obtain a hydrophilic layer 1 with a dry thickness of 2.5 g/m² and a hydrophilic layer 2 with a dry thickness of 0.6 g/m², dried at 120° C. for 3 minutes, and then heat treated. Thereafter, the image formation layer coating solution as shown in Table 3 was coated on the hydrophilic layer 2 to obtain an image formation layer with a dry thickness of 0.6 g/m², dried at 50° C. for 3 minutes, and then subjected to seasoning treatment at 50° C. for 72 hours. Thus, printing plate materials 1 through 8 were prepared.

[Preparation of Hydrophilic Layer 1 Coating Solution]

Materials as shown in Table 1 were sufficiently mixed in the amounts shown in Table 1 while stirring, employing a homogenizer, and filtered to obtain hydrophilic layer 1 coating solution. In Table 1, numerical values represent parts by weight.

TABLE 1

| Materials | Amount |
|---|---|
| Colloidal silica (alkali type): Snowtex XS (solid 20% | 58 |
| by weight, produced by Nissan Kagaku Co., Ltd.) | |
| STM-6500S produced by Nissan Kagaku Co., Ltd. | 2 |
| (spherical particles comprised of melamine resin as | |
| cores and silica as shells with an average particle | |
| size of 6.5 μm and having a convexo-concave surface) | |
| Cu—Fe—Mn type metal oxide black pigment: TM-3550 | 10 |
| black aqueous dispersion {prepared by dispersing TM- | |
| 3550 black powder having a particle size of 0.1 μm | |
| produced by Dainichi Seika Kogyo Co., Ltd. in water | |
| to give a solid content of 40% by weight (including | |
| 0.2% by weight of dispersant)} | |
| Iron oxide black pigment TAROXBL 200 (having an | 2 |
| average particle size of 0.25 μm, produced by Titan | |
| Kogyo Co., Ltd.,) | |
| Layer structural clay mineral particles: | 8 |
| Montmorillonite, Mineral Colloid MO gel prepared by | |
| vigorously stirring montmorillonite Mineral Colloid | |
| MO; gel produced by Southern Clay Products Co., Ltd. | |
| (average particle size: 0.1 μm) in water in a | |
| homogenizer to give a solid content of 5% by weight | |
| Aqueous 4% by weight sodium carboxymethyl cellulose | 5 |
| solution (Reagent produced by Kanto Kagaku Co., Ltd.) | |
| Aqueous 10% by weight sodium phosphate.dodecahydrate | 1 |
| solution (Reagent produced by Kanto Kagaku Co., Ltd.) | |
| Porous metal oxide particles Silton JC 40 (porous | 4 |
| aluminosilicate particles having an average particle | |
| size of 4 μm, produced by Mizusawa Kagaku Co., Ltd.) | |
| Pure water | 10 |

Absorbance per unit weight (absorbance/g) of the hydrophilic layer 1 coating solution, measured employing light with a wavelength of 800 nm, was 0.4.

[Preparation of Hydrophilic Layer 2 Coating Solution]

The materials as shown in Table 2 were sufficiently mixed in the amounts shown in Table 2 while stirring, employing a homogenizer, and filtered to obtain hydrophilic layer 1 coating solution. In Table 2, numerical values represent parts by weight.

TABLE 2

| | Parts |
|---|---|
| | by |
| Materials | weight |
| Colloidal silica (alkali type): Snowtex S (solid 30% | 20.3 |
| by weight, produced by Nissan Kagaku Co., Ltd.) | |
| Necklace shaped colloidal silica (alkali type): | 34.7 |
| Snowtex PSM (solid 20% by weight, produced by Nissan | |
| Kagaku Co., Ltd.) | |
| Cu—Fe—Mn type metal oxide black pigment: TM-3550 black | 5 |
| aqueous dispersion {prepared by dispersing TM-3550 | |
| black powder having a particle size of 0.1 μm produced | |
| by Dainichi Seika Kogyo Co., Ltd. in water to give a | |
| solid content of 40% by weight (including 0.2% by | |
| weight of dispersant)} | |
| Layer structural clay mineral particles: | 8 |
| Montmorillonite: Mineral Colloid MO gel prepared by | |
| vigorously stirring montmorillonite Mineral Colloid | |
| MO; gel produced by Southern Clay Products Co., Ltd. | |
| (average particle size: 0.1 μm) in water in a | |
| homogenizer to give a solid content of 5% by weight | |
| Aqueous 4% by weight sodium carboxymethyl cellulose | 5 |
| solution (Reagent produced by Kanto Kagaku Co., Ltd.) | |
| Aqueous 10% by weight sodium phosphate.dodecahydrate | 1 |
| solution (Reagent produced by Kanto Kagaku Co., Ltd.) | |
| Porous metal oxide particles Silton AMT 08 (porous | 2.4 |
| aluminosilicate particles having an average particle | |
| size of 0.6 μm, produced by Mizusawa Kagaku Co., Ltd.) | |
| Porous metal oxide particles Silton JC 20 (porous | 2 |
| aluminosilicate particles having an average particle | |
| size of 2 μm, produced by Mizusawa Kagaku Co., Ltd.) | |
| Porous metal oxide particles Silton JC 50 (porous | 1 |
| aluminosilicate particles having an average particle | |
| size of 5 μm, produced by Mizusawa Kagaku Co., Ltd.) | |
| Pure water | 16.6 |

Absorbance per unit weight (absorbance/g) of the hydrophilic layer 2 coating solution, measured employing light with a wavelength of 800 nm, was 0.3.

[Preparation of Image Formation Layer Coating Solution]

Materials for the image formation layer coating solution are shown in Table 3.

TABLE 3

| | Parts |
|---|---|
| Materials | by weight |
| Aqueous solution of sodium polyacrylate (average | 1.2 |
| molecular weight: 170,000) AQUALIC DL522 (solid | |
| content 30%), produced by Nippon Shokubai Co., Ltd. | |
| Trehalose (water sluble polymer) | 1.6 |
| Infrared dye AH-1 | 0.2 |
| Dispersion prepared by diluting with pure water | 100 |
| carnauba wax emulsion A118 (having a solid content of | |
| 40% by weight, the wax having an average particle | |
| size of 0.3 μm, a melting viscosity at 140° C. of 8 | |
| cps, a softening point of 65° C., and a melting point | |
| of 80° C., producedby GifuCerac Co., Ltd.) to give a | |
| solid content of 5% by weight | |

Infrared dye AH-1

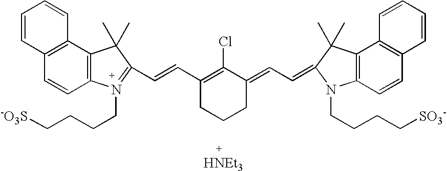

Absorbance per unit weight (absorbance/g) of the image formation layer coating solution, measured employing light with a wavelength of 800 nm, was 0.

<<Preparation of Printing Plate Materials 9 through 14 (Comparative)>>

Printing plate materials 9 through 14 were prepared in the same manner as above, except that supports 6A through 11A as shown in Table 4 were used as a support, respectively. The supports 6A through 11A were prepared employing the substrates 6 through 11 as shown in Table 4 and back coat layers as shown in Table 4 in the same way as above.

<<Preparation of Printing Plate Samples>>

The resulting printing plate material was cut into a size of 730 mm (width)×32 m (length), and wound around a spool made of cardboard having a diameter of 71.9 mm. Thus, a printing plate sample in roll form was prepared.

<<Evaluation of Printing Plate Materials>>

[Measurement of Stiffness]

Stiffness was measured under the following conditions, employing a stiffness meter UT-100-230 produced by Toyo Seiki Seisakusho Co., Ltd.

<Measurement conditions>

| | |
|---|---|
| Sample size: | 10 cm × 8 cm (Effective area: 8 |
| | cm × 8 cm) |
| Angle of elevation: | 10 degrees |
| Pushing amount: | 2 mm |

[Measurement of Smoother]

The printing plate material was subjected to conditioning at 23° C. and at 60% RH (relative humidity) for 2 hours. Thereafter, smoother of the back coat layer surface of the resulting printing plate material was measured based on the J. TAPPI paper pulp test No. 5, employing a smoother SM-6B produced by Toei Denki Kogyo Co., Ltd.

[Measurement of Coefficient of Static Friction]

Coefficient of static friction of the back coat layer surface (hereinafter referred to also as rear surface) of the printing plate material obtained above was measured, employing a static friction coefficient meter TRIOBOGEAR TYPE 10 produced by Shinto Kagaku Co., Ltd.

In the above, the printing plate material was adhered to a horizontal base through an adhesive tape with the rear surface facing upward. A block (having a contact area of 20 mm² and a weight of 200 g), comprised of the same material as the base, was put on the rear surface, and the base was gradually inclined. An inclination angle θ of the base at which the block begins slipping was determined, and tan θ was defined as coefficient of static friction.

The results are shown in Table 4.

In Table 4, the abbreviated names of the substrate materials represent the followings.

PET: Polyethylene terephthalate

LPET: Low density polyethylene terephthalate

HPET: High density polyethylene terephthalate

PEN: Polyethylene naphthalate

TABLE 4

| | | | | | | | Properties of printing | | | |
|---|---|---|---|---|---|---|---|---|---|---|
| | | | | | | | plate material | | | |
| Printing | | | | | | | | | Coefficient | |
| plate | Substrate | | | | Support | | | Smoother | of static | |
| material | Substrate | | thickness | Density | Support | BC | Stiffness | value | friction | |
| sample | No. | Material | (μm) | (g/cm³) | No. | layer | (g) | (MPa) | (tanθ) | Remarks |
| 1 | 1 | PET | 150 | 1.4 | 1A | 1 | 53 | 0.0007 | 0.60 | Inv. |
| 2 | 2 | PET | 175 | 1.4 | 2A | 1 | 85 | 0.0007 | 0.60 | Inv. |
| 3 | 3 | PET | 200 | 1.4 | 3A | 1 | 130 | 0.0007 | 0.60 | Inv. |
| 4 | 4 | PET | 250 | 1.4 | 4A | 1 | 300 | 0.0007 | 0.60 | Inv. |
| 5 | 5 | PET | 300 | 1.4 | 5A | 1 | 700 | 0.0007 | 0.60 | Inv. |
| 6 | 2 | PET | 175 | 1.4 | 1B | 2 | 85 | 0.07 | 0.25 | Inv. |
| 7 | 2 | PET | 175 | 1.4 | 1C | 3 | 85 | 0.05 | 0.32 | Inv. |
| 8 | 2 | PET | 175 | 1.4 | 1D | 4 | 85 | 0.03 | 0.41 | Inv. |
| 9 | 6 | PET | 175 | 1.4 | 6A | — | 85 | 0.0003 | 0.71 | Comp. |
| 10 | 7 | PET | 100 | 1.4 | 7A | 3 | 24 | 0.05 | 0.32 | Comp. |
| 11 | 8 | PET | 350 | 1.4 | 8A | 3 | 1400 | 0.05 | 0.32 | Comp. |
| 12 | 9 | LPET | 175 | 1.1 | 9A | 3 | 35 | 0.05 | 0.32 | Comp. |
| 13 | 10 | HDPE | 175 | 1.2 | 10A | 3 | 20 | 0.05 | 0.32 | Comp. |
| 14 | 11 | PEN | 175 | 1.4 | 11A | 3 | 2200 | 0.05 | 0.32 | Comp. |

Inv.: Inventive,
Comp.: Comparative

<<Preparation of Printing Plate>>

The printing plate sample in the roll form was cut in a length of 860 mm in the direction in which the sample was wound. The resulting sample was exposed under reduced pressure as shown in Table 5, employing an exposure apparatus, having a structure as shown in FIG. 1, comprising an exposure unit of an 830 nm semiconductor laser and an exposure drum with a diameter of 350 mm having suction through-holes for fixing the sample. On exposure above, focal point of the exposure beams was adjusted so that the spot diameter of the beams was smallest in the sample surface to be exposed.

As an exposure drum were used an exposure drum 1 having suction through-holes in which all of the aperture area were the same and an exposure drum 2 having suction through-holes in which the aperture area of the suction through-holes at the central portion was smaller than that at the edge portions.

The sample was fixed to the drum under reduced pressure in which an output power of a vacuum pump connected to drum was controlled to give the pressure (reduced) as shown in Table 5.

The spot diameter of the laser beams was about 18 μm, and the resolving power in the sub-scanning direction of the laser was about 2400 dpi. The sample was exposed at a screen line number of 175 lines/inch. The “dpi” herein implies dot numbers per 2.54 cm.

The exposure energy was adjusted to give 150 to 350 mJ/cm² at the sample surface by controlling the output power of the laser and the rotation number of the exposure drum.

(Measurement of a Degree of Flatness of the Sample on the Exposure Drum)

When the sample was fixed to the exposure drum, flatness was measured along portions 20 mm in from each of the four sides of the sample, and the degree of flatness was determined. The degree of flatness was measured by means of a flatness meter Soaring Eye TS-8000 (produced by Soatec Corp.).

<<Evaluation of Printing Plate Sample>>

Printing was carried out under the following conditions employing the exposed printing plate material sample obtained above, and the sample was evaluated for various properties as a printing plate. <<Printing Method>>

(Printing Method)

Press: DAIYA 1F-1 (produced by Mitsubishi Jukogyo Co., Ltd.)

Printing paper: Mu Coat (104.7 g/m²) (produced by Hokuetsu Seishi Co., Ltd.)

Dampening water: a 2% by weight solution of Astromark 3 (produced by Nikken Kagaku Kenkyusyo Co., Ltd.)

Printing ink: the following two inks were used.

Ink 1: Toyo King Hyecho M Magenta (produced by Toyo Ink Manufacturing Co.)

Ink 2: TK Hyecho SOY 1 (soy bean oil ink, produced by Toyo Ink Manufacturing Co.)

(Evaluation)

<Developability)

Printing was carried out employing the exposed printing plate sample obtained above in the same sequence as the printing sequence carried out employing a conventional PS plate, and the number of printing paper sheets printed from when printing started to when ink at the non-image portions was completely removed were determined.

<Ink Transferability>

Printing was carried out varying a supplied amount of dampening water or printing ink employing two kinds of inks above. Ink transferability to the printed paper was visually observed and evaluated according to the following criteria:

A: When ink was supplied in an amount of 50% of the normal supplied amount or in an amount of 150% of the normal supplied amount, excellent images were obtained.

B: When ink was supplied in an amount of 70% of the normal supplied amount or in an amount of 130% of the normal supplied amount, filling-up occurred at dotted images and density unevenness at solid images.

C: When ink was supplied in an amount of 80% of the normal supplied amount or in an amount of 120% of the normal supplied amount, filling-up occurred at dotted images and density unevenness at solid images, which was problematic for practical use.

<Printing Quality>

After 20,000 copies were printed, a solid image, a 50% dot image and a 2% dot image of the 20,000^{th} printed paper were visually observed, and the printing quality was evaluated according to the following criteria:

A: Printing quality is good.

B: Image defect and the lack of the dot are observed at the area of less than 10% of the image portions.

C: Image defect and the lack of the dot are observed at the area of not less than 10% of the image portions.

<Printing Durability>

<<Printing Durability>>

Printing durability was expressed in terms of the number of printing paper sheets printed from when printing started toll when a 3% dot image lacked not less than 50% of the dots was counted. Thirty thousand copies were printed.

The results are shown in Table 5.

TABLE 5

| | | | | Evaluation of properties | | | | | | | | |
|---|---|---|---|---|---|---|---|---|---|---|---|---|
| | | | | | | | | | | | Printing | |
| | | Exposure | | Degree | | Ink | | | | | durability | |
| | Printing | condition | | of | Developability | transferability | | Printing quality | | | (× 1000 | |
| Printing | plate | Exposure | Pressure | flatness | (by | Ink | Ink | Solid | 50% dot | 2% dot | by | |
| plate | material | drum | (kPa) | (μm) | number) | 1 | 2 | image | image | image | number) | Remarks |
| 1 | 1 | 1 | 73.2 | 35 | 5 | A | A | A | A | A | 21 | Inv. |
| 2 | 1 | 2 | 73.2 | 29 | 4 | A | A | A | A | A | 24 | Inv. |
| 3 | 2 | 1 | 73.2 | 24 | 5 | A | A | A | A | A | 24 | Inv. |
| 4 | 3 | 1 | 73.2 | 18 | 5 | A | A | A | A | A | 24 | Inv. |
| 5 | 4 | 1 | 73.2 | 12 | 6 | A | A | A | A | A | 24 | Inv. |
| 6 | 5 | 1 | 73.2 | 10 | 8 | A | A | A | A | A | 22 | Inv. |
| 7 | 6 | 1 | 73.2 | 20 | 5 | A | A | A | A | A | 22 | Inv. |
| 8 | 7 | 1 | 73.2 | 30 | 5 | A | A | A | A | A | 22 | Inv. |
| 9 | 8 | 1 | 73.2 | 33 | 5 | A | A | A | A | A | 24 | Inv. |
| 10 | 8 | 2 | 73.2 | 27 | 4 | A | A | A | A | A | 26 | Inv. |
| 11 | 7 | 1 | 46.6 | 45 | 6 | A | A | A | A | A | 24 | Inv. |
| 12 | 7 | 2 | 46.6 | 38 | 5 | A | A | A | A | A | 26 | Inv. |
| 13 | 7 | 1 | 86.5 | 50 | 8 | A | A | A | A | A | 21 | Inv. |
| 14 | 7 | 1 | 93.1 | 72 | 11 | A | B | A | B | B | 19 | Comp. |
| 15 | 9 | 1 | 73.2 | 65 | 18 | A | B | A | B | C | 16 | Comp. |
| 16 | 10 | 1 | 73.2 | 72 | 19 | A | B | A | C | C | 9 | Comp. |
| 17 | 11 | 1 | 73.2 | 55 | 16 | B | B | B | B | C | 15 | Comp. |
| 18 | 12 | 1 | 73.2 | 90 | 32 | B | C | B | B | C | 8 | Comp. |
| 19 | 13 | 1 | 73.2 | 110 | 51 | B | C | B | C | C | 5 | Comp. |
| 20 | 14 | 1 | 73.2 | Fixing | — | — | — | — | — | — | — | Comp. |
| | | | | fault | | | | | | | | |

Inv: Inventive,
Comp.: Comparative

As is apparent from Table 5, the inventive printing plate material samples provide a printing plate having excellent developability, excellent ink transferability, excellent printing quality, and high printing durability.

### Example 2

A printing plate material sample was prepared in the same manner as in Example 1 above. The printing plate material sample was fixed on an exposure plate as shown in FIG. 3 instead of the exposure drum used in Example 1 and exposed in the same manner as in Example 1. The exposed printing plate material sample was processed and evaluated in the same manner as in Example 1. It has been proved that the inventive printing plate material samples provide a printing plate having excellent developability, excellent ink transferability, excellent printing quality, and high printing durability.

What is claimed is:

1. A process of preparing a printing plate from a printing plate material comprising a support, and provided thereon, an image formation layer, the process comprising the steps of:
fixing the printing plate material onto a fixing member with suction through-holes by suction that evacuates air through the suction through-holes, the surface (rear surface) of the support opposite the image formation layer facing the fixing member; and
imagewise exposing the fixed printing plate material to laser to form an image on image formation portions of the image formation layer,
wherein a degree of flatness of the surface on the image formation layer side of the fixed printing plate material is not more than 50 μm.

2. The process of claim 1, wherein the fixing member is a cylindrical drum, and the imagewise exposure is carried out from the outside of the drum while the drum is rotated.

3. The process of claim 1, wherein the aperture area of the suction through-holes at the central portion of the fixing member is smaller than that at the edge portions of the fixing member.

4. The process of claim 1, wherein the printing plate material has a total thickness of from 150 to 300 μm, a stiffness of from 0.50 to 5.00 N, and an average density of from 1.4 to 1.8 g/m³.

5. The process of claim 1, wherein the rear surface of the fixed printing plate material has a smoother value of not more than 0.06 MPa, and a coefficient of static friction of the rear surface to the fixing member is from 0.3 to 0.6.

6. The process of claim 1, wherein the support is flexible.

7. The process of claim 6, wherein the support is a polyethylene terephthalate or polyethylene naphthalate film sheet.

8. A printing plate material comprising a support, and provided thereon, an image formation layer, wherein the printing plate material is fixed onto a fixing member with suction through-holes according to a vacuum evacuation method, the surface (rear surface) of the support opposite the image formation layer facing the fixing member, and then the image formation layer is imagewise exposed to laser to form an image, a degree of flatness of the surface on the image formation layer side of the fixed printing plate material being not more than 50 μm.

9. The printing plate material of claim 8, wherein the printing plate material has a total thickness of from 150 to 300 μm, a stiffness of from 0.50 to 5.00 N, and an average density of from 1.4 to 1.8 g/m³.

10. The printing plate material of claim 8, wherein the rear surface of the fixed printing plate material has a smoother value of not more than 0.06 MPa, and a coefficient of static friction of the rear surface to the fixing member is from 0.3 to 0.6.

11. The process of claim 8, wherein the support is flexible.

12. The process of claim 11, wherein the support is a polyethylene terephthalate or polyethylene naphthalate film sheet.

13. The printing plate material of claim 8, wherein the image formation layer contains a light-to-heat conversion material.

14. The printing plate material of claim 8, further comprising a hydrophilic layer.

15. The printing plate material of claim 14, wherein the image formation layer or the hydrophilic layer contains a light-to-heat conversion material.
